(19) United States
(12) Patent Application Publication
(10) Pub. No.: US 2012/0311972 A1
(43) Pub. Date: Dec. 13, 2012

(54) Disposable Container for Absorbing Oils, Fats and Greases

(76) Inventor: James D. Hunter, Thornton, CO (US)

(21) Appl. No.: 13/156,395

(22) Filed: Jun. 9, 2011

(51) Int. Cl. B65B 3/04; B23P 19/00; B65D 81/38

(52) U.S. Cl. 53/471; 220/592.2; 29/428

(57) ABSTRACT

A disposable container for receiving and containing used oil, fat and grease. The disposable container is comprised substantially of biodegradable materials and utilizes a lightweight oil absorbing material. In at least one version, the oil absorbing material comprises perlite.

### BACKGROUND

Oils fat and/or greases are either used or released during the process of cooking many types of food. Often, especially when their temperature is elevated, these substances are in a liquid form. While it is possible to pour the liquid down the sink, the substances can cause processing problems. Just as significantly, the substance can solidify, coat the drain pipe and eventually cause a clog or back up. Further, grease can also block or clog inlet drains on septic systems and because grease often does not degrade readily it can hinder the proper operation of the system as it builds up.

Because of the foregoing problems, many municipal codes prohibit the dumping of liquefied grease, oils and fats down the drain. Further, because these substances can be harmful to the environment, many municipal codes also prohibit these substances to be thrown out with the trash while in free flowing liquid form or in a form that can easily become liquid upon the application of heat. Proper disposal requires the substance to be bound in a stable solid form. One of the more common manners to solidify liquefied fats, greases and oils so that the substance can be safely and easily disposed of is to pour the substance over a solid medium that effectively absorbs it. The at least partially saturated medium can then be disposed of in the trash in a manner similar to that used for other solid materials.

Most materials used to absorb oils, greases and fats are granular, such as clay, or fibrous, such as peat moss, and as such are not convenient to use. While home cook could keep a bag of absorbent granular clay in a cupboard to be pulled out, poured into a container or in the pan/pot containing the liquefied grease and then discarded into the trash, it is unlikely he/she would do so because of the relative inconvenience. Further, some of the grease-soaked granular material could spill out of its container and cause a mess. Also worth note; the amount of oil absorbed for a certain weight and/or volume of material can be rather low, thereby necessitating more storage space for the material among kitchen space that might already be in short supply. As a final concern granular clays often produce a fine dust which has been shown to be carcinogenic.

### BRIEF DESCRIPTION OF THE DRAWINGS

FIG. 1 is an isometric view of a disposable container for receiving and containing oil, grease, and fat according to embodiments of the present invention.

FIG. 2 is a cut away side view of the disposable container of FIG. 1 according to a first embodiment of the present invention.

FIG. 3 is an isometric view of the disposable container of FIG. 1 with the container's cover removed according to the first embodiment of the present invention.

FIG. 4 is an exploded view of the disposable container of FIG. 1 according to the first embodiment of the present invention.

FIG. 5 is an exploded view of the disposable container of FIG. 1 according to a second embodiment of the present invention.

FIG. 6 is cut away side view of the thermal liner of the disposable container of FIG. 1 according to the second embodiment of the present invention.

FIG. 7 is an isometric view of the container of FIG. 1 positioned below a straining bowl and associated elevating framework according to another embodiment of the present invention.

FIG. 8 is an isometric view of a unitary thermal liner and perforated top typically comprised of a polymeric material for use in embodiments of the present invention.

FIG. 9 is an isometric view of a combination cover and perforated top typically comprised of a polymeric material for use in embodiments of the present invention.

### DETAILED DESCRIPTION

Embodiments of the present invention comprise a disposable container filled with a substance capable of absorbing many times its weight of oil, grease and fat. The container typically comprises a biodegradable containment body (receptacle) made of paper optionally lined or coated with polymeric barrier layer, although biodegradable plastics and non-biodegradable materials including papers and plastics can be used as well. A cover typically constructed of a similar material is provided to seal the receptacle. The inside of the receptacle is at least partially and typically substantially filled with a suitable absorbing material that can be granular or fibrous in nature. A thermal liner comprised of corrugated paper or some other biodegradable material is provided along the inside wall or outside wall of the receptacle to permit a user to handle the container while it contains hot grease, oil or fat therein without significant risk of being burned. Within the receptacle over the absorbing material a perforated cover is provided to help contain the absorbing material in the container and minimize the risk of material spillage but still permitting the liquid grease/oil to flow there through. Like the receptacle and the thermal liner, the cover is typically made of a biodegradable material.

Containers of various sizes and capacities can be produced for handling differently sized jobs. For instance a quart-sized container would be a desirable size for many home cooking environments where only a limited amount of grease is generated at any one time; whereas, a ½ gallon or even gallon size container would be useful for certain restaurants or to dispose of oil used in a deep fryer.

In at least one embodiment, a dishwasher safe strainer is provided that is placed on top of an elevating stand. The container sans cover is placed underneath the strainer permitting the user to pour the hot grease/fat from a frying pan or other grease receptacle thereby straining out any food particles or debris.

Advantageously, embodiments of the invention permit a user to safely and easily dispose of his/her unwanted kitchen grease, fat and oil by pouring it into a landfill friendly container as opposed to (i) collecting the unsightly and potentially unsanitary material for eventual disposal by unknown means in the future, or (ii) pouring the material down the drain and potentially creating a clogging event.

### TERMINOLOGY

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” or “generally” as used herein unless otherwise indicated means a margin of +−20% when modifying a numerical value. Also, as applicable, the term “substantially” as used herein unless otherwise indicated means a margin of +−10% relative to a numerical value. The term “substantial” when applied to an area or volume means about 75% or more of the applicable total. It is to be appreciated that not all uses of the above terms are quantifiable such that the referenced ranges can be applied and as such where the indicated margins are not readily applicable, the foregoing terms have meanings attributable to them as would be understood by someone of ordinary skill in the art given the benefit of this disclosure.

As used herein the term “oil” shall include liquefied grease and liquefied fat.

As used herein, the term “perforated” refers to a surface having a plurality of holes or openings distributed thereon that extend through the surface.

As used herein, the terms “plastic” and “polymeric material” are used interchangeably.

### A First Embodiment of a Disposable Container for Grease, Oil and Fat

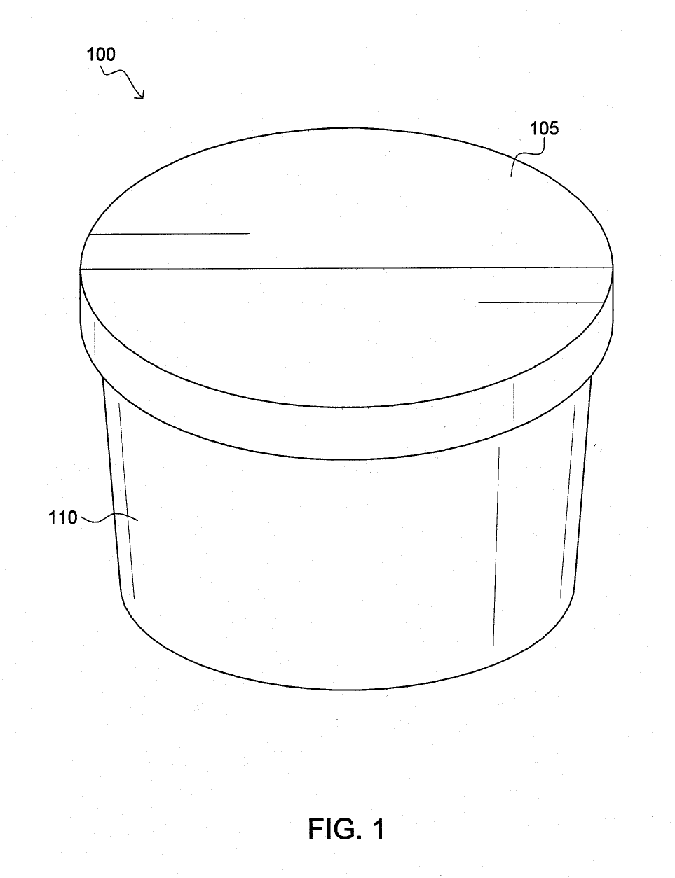

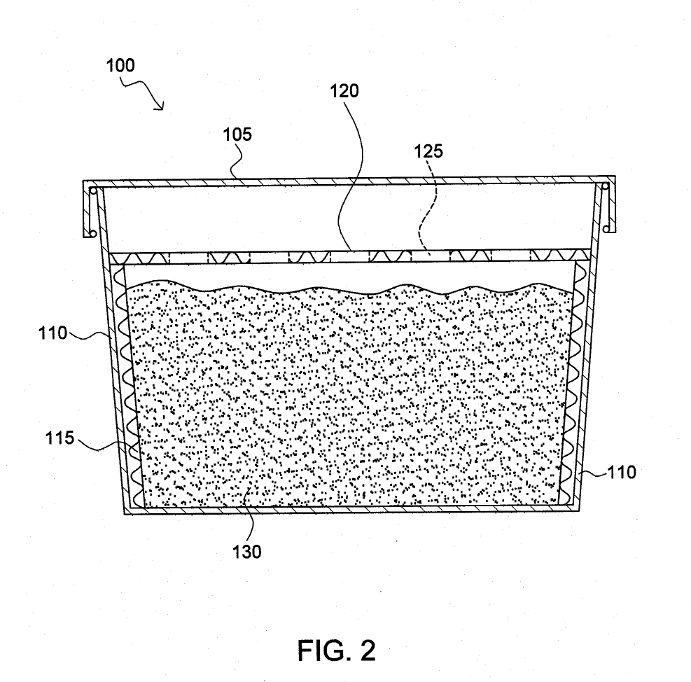

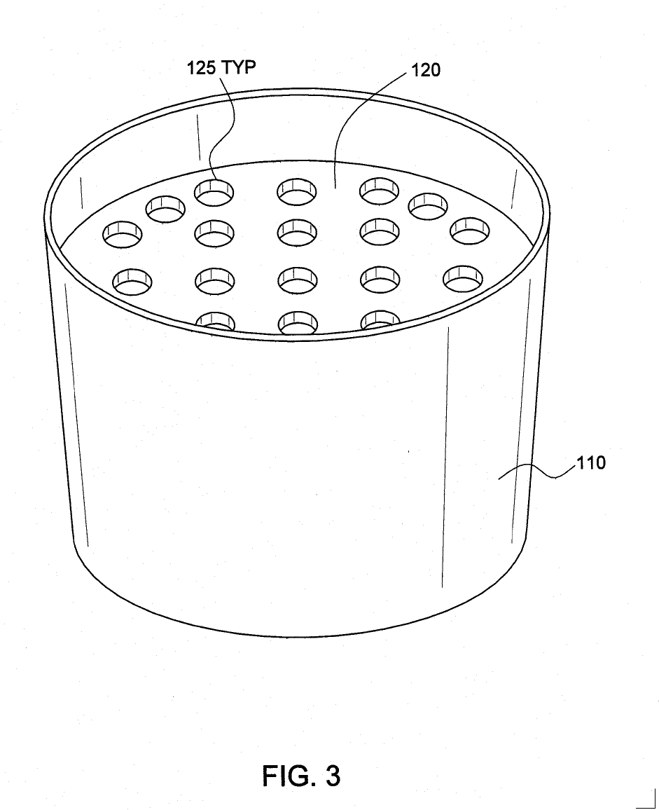

Referring primarily to FIGS. 1-4, a first embodiment of a disposable container 100 for grease, oil and fat is illustrated. The container comprises a receptacle 110, a receptacle cover 105, a thermal barrier 115 (also referred to as a thermal liner), oil absorbing particulate 130 and a perforated top 120. Preferably, the various components except for possibly the particulate are comprised of biodegradable materials most typically paper products. The particulate can also be comprised of biogreadable materials but in at least one variation comprises essentially inert amorphous silica.

The receptacle 110 can be of any suitable shape and size. Larger sizes are contemplated for restaurant or commercial food preparation use; whereas, small sizes, such as a 32 ounce capacity receptacle, are contemplated for residential kitchen or recreational vehicle use. Most typically, the receptacle will have a cylindrical cross section and be at least partially frustoconical if for no other reason than this shape is most economically produced. Other shapes are contemplated including but not limited to cylindrical and cuboid receptacles. Generally speaking the receptacle includes at least one sidewall and a bottom side that define an interior volume. An open top end is provided through into which oil can be poured.

As indicated, the receptacle 110 is most typically comprised of a biodegradeable material, such as paper, but other biodegradeable materials, such as certain biodegradable plastics can be used as well. Other variations are contemplated that do not necessary use biodegradable materials. For instance, variations made of combustible materials that may or may not be biodegradable are contemplated permitting ultimate disposal using incineration. In at least one variation, the receptacle is comprised of a paper coated on either the inside and/or the outside with a polymeric barrier film to prevent the oil from seeping through the container. One type of barrier film comprises polyethylene although other types, especially those which are considered biodegradable, can be used. In yet other variations, a wax barrier coating can be used, although ideally such a coating would have a melting temperature above the temperature of the hot oil that is intended to be poured into the container.

The receptacle cover 105 is typically comprised of the same materials as its mating receptacle 110, although in some variations plastic covers can be used. It is typically received tightly over an open top end of the receptacle most often through an interference fit. For point of reference, in at least one variation the receptacle and its associated cover are substantially similar to paper soup containers that are used by many restaurants for delivery and take-out orders.

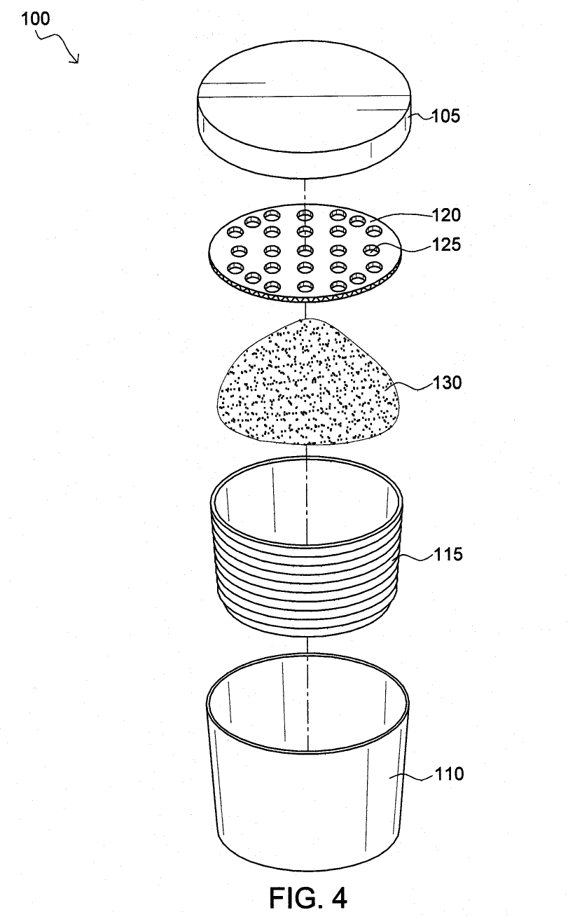

A thermal barrier 115 is provided to facilitate the handling of the container 100 even when filled with hot oil. In the illustrated embodiment, the thermal barrier lines a substantial portion of the inside surface of the at least one sidewall. The thermal barrier can comprise an appropriately shaped sheet of corrugated paper that is rolled and fit inside the receptacle 110 with its lengthwise edges overlapping. Alternatively, as illustrated, the barrier can comprised a frustoconical cylinder configured to fit snuggly in the receptacle. As can be best seen in FIG. 4, the illustrated barrier comprises a single faced corrugated fiberboard with the face facing inwardly and the corrugated outside facing the inside surface of the at least one sidewall. As can be appreciated other fiberboard configurations can be used. The single face can optionally be coated, such as with a polymeric material, to prevent soaking by the liquid oil but generally absorption of oil by the barrier is not of significant concern.

Numerous variations of the thermal barrier 115 are contemplated. For instance, a thermal barrier can be applied around the outside surface of the at least one sidewall instead of the inside surface. In other variations, the barrier can be comprised of a polymeric foam material instead of corrugated fiberboard that is fit against either the inside or outside surface of the at least one wall. In yet another variation, the receptacle and the thermal liner can be integral to each other wherein the at least one side wall comprises a two or three faced corrugated fiberboard product or a sheet foam material.

A substantial portion of the interior of the receptacle 110 is filled with an oil absorbent material 130. Materials known to absorb oil include coconut coir, peat moss and clay. Each of the materials has different levels of effectiveness varying in ability to absorb oil by weight or volume. As can be appreciated, certain absorbent materials result in a heavier dry container; whereas, other choices may reduce effectiveness. Although embodiments of the container are contemplated that use one or combination of known oil absorbing materials, ultimately a material is desired that can absorb a significant amount of oil relative to both its weight and volume. Accordingly, with a more efficient absorbent material, the container can be made both smaller and lighter for a given oil holding capacity.

Expanded perlite, amorphous alumina silicate, is used as an absorbent material 130 (also referred to herein as “absorbant” and “absorbing material”) in embodiments and variations of the disposable container. Expanded perlite having a preferable particulate size of about 60 mu. to 2019 mu. is known to be capable of absorbing up to about 8-10 times its weight in oil. Further, expanded perlite has a relatively low density permitting disposable containers to be produced that are both smaller and lighter than containers having a similar oil absorbent capacity that utilize other absorbent materials, such as clay. As can be appreciated small and lighter containers can be more efficiently packaged and shipped thereby reducing the cost to bring a disposable container to market. In some, but not necessarily all, variations, the expanded perlite is treated with a solution to enhance the adherence of the perlite particles to one another to reduce the generation of airborne perlite dust. One such solution includes a mixture of hydrated 1,2,3-propanetriol and water soluble polymers.

To help maintain the absorbent material 130 in place within the receptacle 110, the perforated top 120 is provided. In this embodiment, the perforated top typically comprises a planar disk fabricated from corrugated fiberboard or another suitable material (including but not limited to paper and biodegradable plastics) that rests on and is supported by the top edge of the thermal barrier 115. As can be appreciated alternative tops are contemplated that comprise a fabric or metallic screen material with, as necessary, an appropriate plastic or metal hoop framework.

As illustrated, the top is perforated with a plurality of holes 125. The size of the holes and their number can vary depending on the variation of the container but are generally sufficient in size and number to permit oil to flow quickly therethrough. The purpose of the top is multifold: it acts to help contain the particulate within the receptacle; and it also acts to strain food debris that can be disposed of conventionally. In some variations, the size of the perforations or holes 125 can be less than the smaller sizes of the absorbent material 130 particulate to prevent the absorbent from being released from the container.

### A Second Embodiment of a Disposable Container for Grease, Oil and Fat

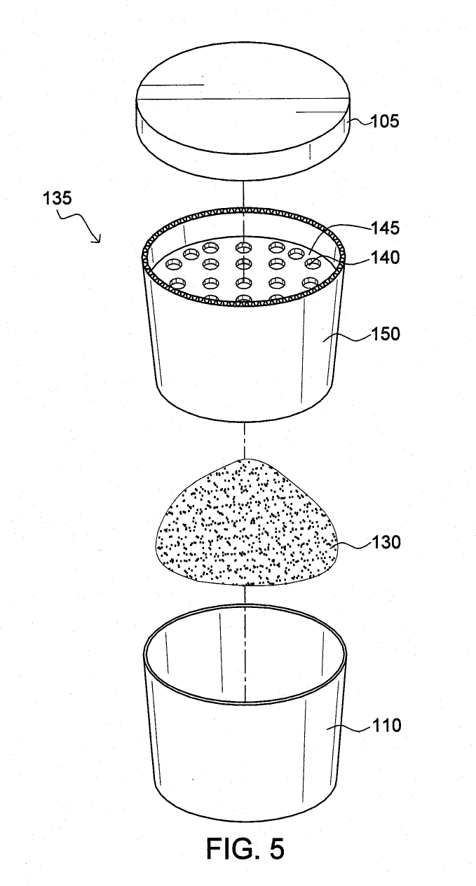

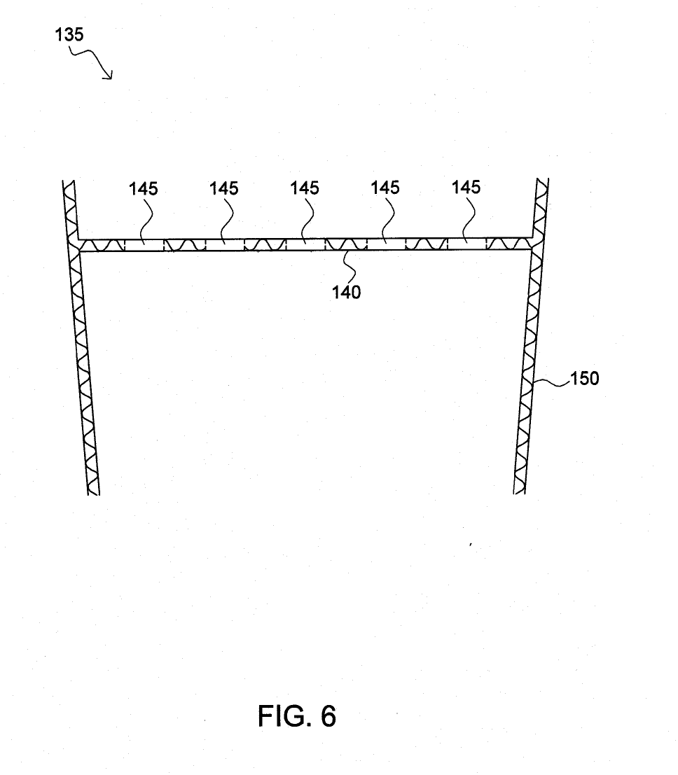

A second embodiment of the disposable container is illustrated in FIGS. 5 & 6. Functionally it is substantially similar to the first embodiment. Additionally, the receptacle 110, the cover 105 and the absorbent material 130 are substantially similar to the respective receptacle, cover and absorbent material described with reference to the first embodiment. The primary differences between the first embodiment and the second pertain to the design and configuration of the thermal barrier and the perforated top. In particular, the top 140 and the barrier 150 are fabricated as a single unit 135 in the second embodiment as best shown in the cross sectional view of FIG. 6.

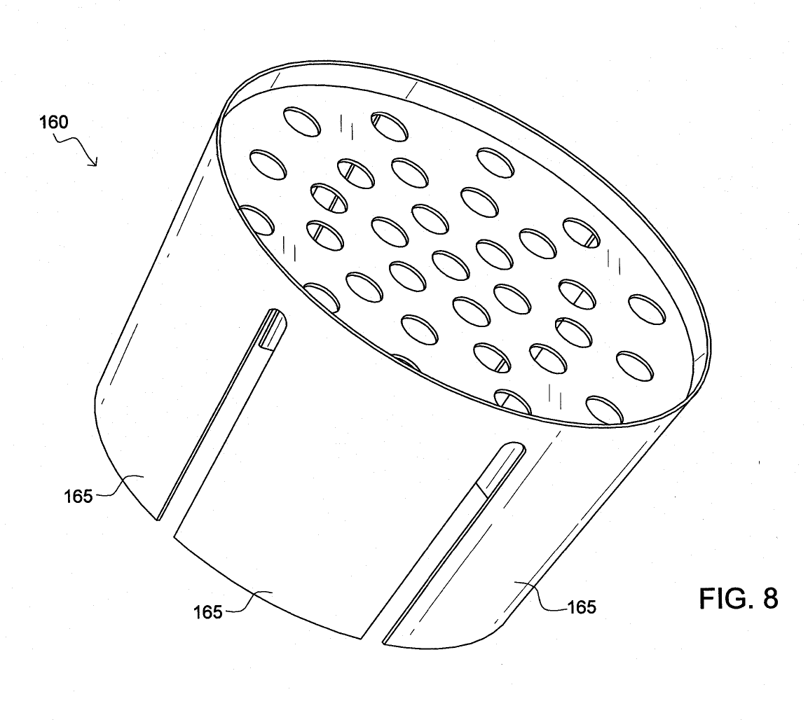

As illustrated in FIG. 6, the combination unit 135 of the top 145 and the barrier 150 is fabricated of double faced corrugated fiberboard, although other suitable materials can be utilized including plastic as is discussed in reference to FIG. 8 below. As with the top described above relative to the first embodiment, the top portion on the integral unit also includes a plurality of holes 140 or perforations to permit the hot oil to pass to the absorbing material while straining food particulate.

FIG. 8 is an illustration of an alternative combination unit 160 comprised of a biodegradable plastic. Of note are the downwardly extending arcuate tabs 165 that together for a frustoconical shape and serve as a thermal barrier when butted up against the inside surface of the receptacle's at least one wall. These tabs, which are capable of biasing flex permit the unit to be securely fit within the inside of the receptacle 110. The ability of a solid plastic thermal barrier to insulate the user's hand from the heat of hot oil is likely to be reduced when compared to corrugated fiber board; however, it does provide sufficient protection for the amount of time the user has to hold the container to minimize any discomfort and risk of being burned.

### A Third Embodiment of a Disposable Container for Grease, Oil and Fat

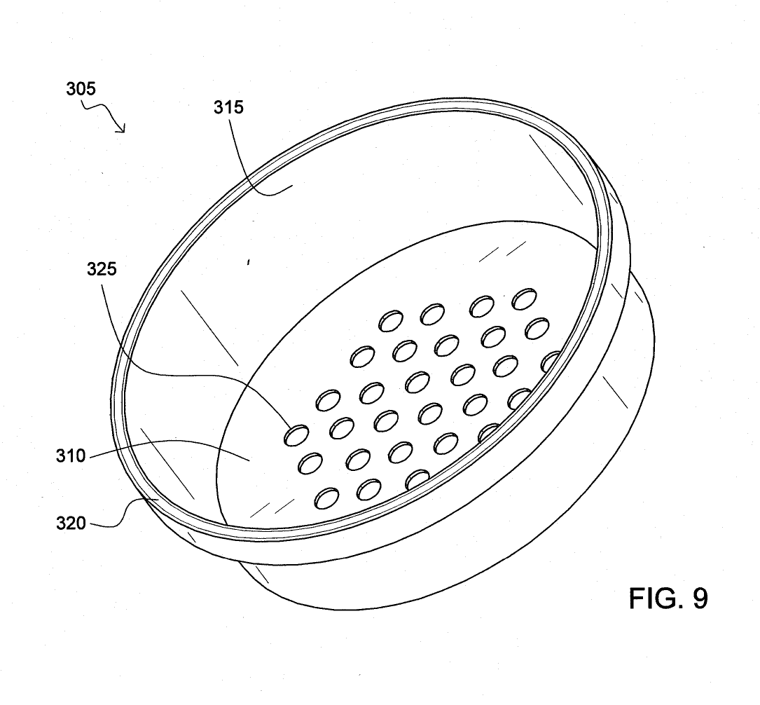

A third embodiment of the container is similar to the first embodiment with the cover 105 and perforated top 120 being replaced with the unitary cover and top combination 305 as illustrated in FIG. 9. As provided prior to use a film/sheet (not shown) of plastic or paper is secured over the top of the provided perforations 325 to the adjoining surface of the top portion 310 typically through the use of a suitable adhesive. When a person is ready to use the container, he/she simply removes the film to expose the perforations and the absorbing material therebelow.

Of important note, the top portion 310 is recessed below the lip of the receptacle 110 in a manner similar to how the separate top 120 of the first embodiment is recessed below the lip. A sidewall portion 315 extends upwardly from and interfaces with the top portion 310. The top edge of the sidewall portion interfaces with a annular lip 320 that is configured to be received over the top edge of the receptacle to secure the cover and top combination in place.

The cover and top combination is typically molded from paper or plastic using traditional methods. In some variations of the third embodiment a secondary cover (not shown) may be provided in place of or in addition to the film that is secured over the lip of the combination. In this variation, the secondary cover can be placed back over the container after it has been used to prevent any of the granular materials from escaping from the container when the container is disposed off. In other variations, the perforations 325 can sized to be smaller than most of the grains of absorbing material further preventing any absorbing material spillage upon container disposal.

A System including a Disposable Grease/Fat/Oil Container, a Strainer and Stand

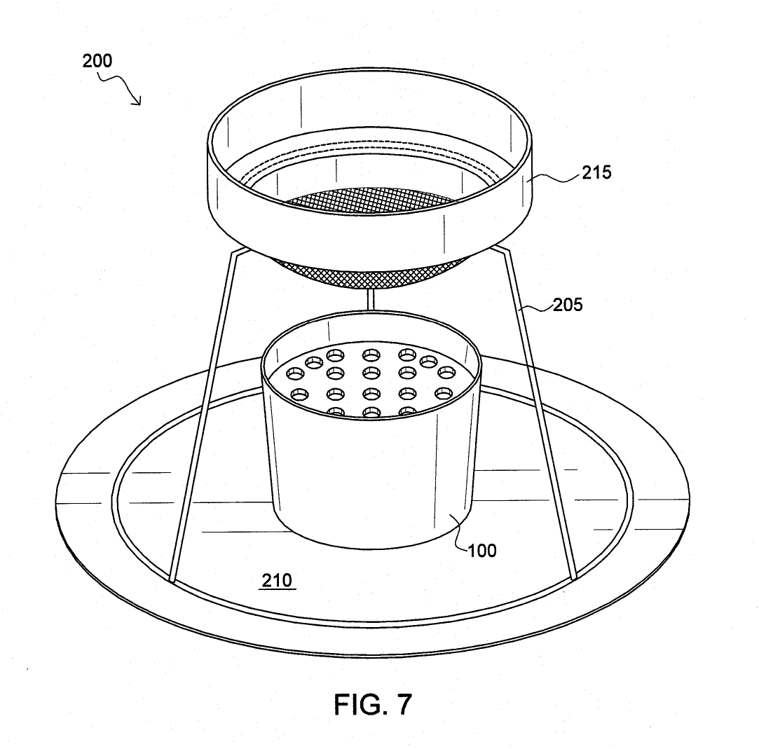

Referring to FIG. 7, a system 200 comprising the disposable container 100 of the first or second embodiments in combination with a strainer bowl 215, a supporting stand 205 and a plate 210 is illustrated. Using the foregoing system a user can quickly and easily both strain food particles from used cooking oil and package the oil for solid waste disposal. This combination is particularly advantageous for use with cooking oil that has too great an amount of larger food particles to be strained by the container's perforated top 120.

Ideally, the plate 210 has an indentation or other markings to permit a user to center an appropriately-sized disposable container 100 thereon. Further the plate can include a ridge, an annular indentation or other suitable features to permit a user to properly position the stand 205 over the container.

The stand 205 can be fabricated from any suitable material including metal wire and/or plastic trusses. The stands primary function is to hold the strainer bowl 215 centered above the container opening such that oil as it is poured into and subsequently passes through the bowl is received in the container there below.

The bowl 215 generally resembles a colander that fits into and on a ring or other features provided on the stand 205. The bowl like the plate can be fabricated of any suitable material including plastics, metals, ceramics or a combination thereof. For instance the straining portion of the bowl can comprise a metal screen; whereas, the sidewalls that funnel oil to the screen can comprise a plastic. Alternatively, the screen portion can be molded of plastic integrally with the sidewalls. Preferrably, the plate, stand and bowl are dishwasher safe so that they can be easily cleaned up without much effort on the part of the user.

A Method of using a Disposable Grease/Fat/Oil Container

As indicated, embodiments of the disposable container described above and their variations as well as any and all other embodiments that read upon the appended claims can be utilized to assist in the safe, easy and proper disposal of waste cooking oils, greases and fats.

To use one of the embodiments to dispose of waste cooking oil, a user first selects a container 100 of an appropriate size. For instance, a disposable container having a 32 ounce receptacle has been found to be the appropriate size to absorb and contain about eight ounces of oil perhaps a bit more. Given this ratio, a gallon container can hold at least thirty two ounces of oil. After selecting the properly-sized container, the cover 105 is removed from the container and placed aside for future use.

If the user is using the disposable container in conjunction with the aforementioned strainer bowl 215, plate 210 and stand 205 combination, he/she places the open container on the plate under the stand with the strainer bowl positioned directly there above. If the container is being used by itself, it is simply placed on an appropriate flat surface perhaps in the sink tub or on an absorbent towel to mitigate problems associated with the spillage of any hot oil during transfer to the container.

Hot oil is poured into the container typically from a pot or pan that was previously used to cook a food product. Where the strainer bowl is used, the contents of the pan or pot are poured into the bowl with the oil passing through the bowl to the container below and any food particles being retained in the bowl. Where no strainer bowl is utilized, the hot oil passes through the perforations in the container's perforated top with any larger solid particulate remaining on the surface of the top.

Once the oil has been poured into the container, the cover is placed back on the container for disposal by suitable means. If the capacity of the container has not been reached a user can store the container in a suitable location to be used again at a later time.

### A Method of Making a Disposable Grease/Fat/Oil Container

Numerous methods of making the disposable container 100 using the components and materials described herein are contemplated depending on factors including the size of the receptacle, the type of absorbent material specified and the type of thermal liner utilized.

The central component to the disposable container comprises the receptacle 110. The illustrated receptacle is reminiscent of a paper soup container; however containers of other shapes, sizes, construction and configurations can be utilized depending on desired product characteristics. A cover 105 of suitable size and configuration is also provided to seal the open end of the container. In at least one contemplated variation, the cover can be integral and unitary with the receptacle.

A thermal barrier 115 is provided to minimize the transfer of heat from the hot oil once received in the receptacle to the at least one side wall and to the hand of a user holding the container. As shown the barrier can be placed against the inside surface of the receptacle's side wall or on the outside thereof. Usually, but not necessarily the barrier is placed into the receptacle before the absorbent material is added.

Oil absorbing material 130 is provided to absorb the oil and bind it as a solid so that the oil and the container can be disposed of using conventional solid waste disposal means. As indicated the absorbent in at least one embodiment comprises expanded perlite but other types of absorbents can be used as well. Typically a suitable amount of absorbent is poured into the container filling a substantial portion of the receptacle's interior volume but leaving some space between the lip of the open end.

A perforated top 120 is provided and placed over the absorbing material. In some variations the top comprises a planar disk with a pluraily of holes 125 in it that is placed over and rests upon a top edge of the thermal barrier. In other embodiments, the top is unitary and integral with the thermal barrier. As can be appreciated once the absorbing material, the thermal barrier and the perforated top are all assembled within the container, the cover is placed over the receptacle.

In some variations a sheet of removable plastic or paper sheet having a partially adhesive backside may be placed over the perforated top prior to assembly and often during the fabrication of the top itself. The plastic sheet can include a tab by which a user can pull off the sheet prior to use of the container. The sheet helps prevent the movement of some of the absorbing material from its desired location below top to above it during transport and handling of the container. Also, to facilitate transport, a band of shrink wrap plastic can be secured around the interface between the cover and the receptacle to secure the cover in place. The user would simply tear off the band when he/she is readying the container for use.

### OTHER VARIATIONS AND EMBODIMENTS

The various preferred embodiments and variations thereof illustrated in the accompanying figures and/or described above are merely exemplary and are not meant to limit the scope of the invention. It is to be appreciated that numerous variations to the invention have been contemplated as would be obvious to one of ordinary skill in the art with the benefit of this disclosure.

1. A container for holding oil, the container comprising:
a receptacle having at least one sidewall, a bottom and an at least partially open top end defining an interior volume;
a cover adapted for receipt over the open top end to at least substantially enclose the interior volume;
a thermal barrier distinct from the at least one sidewall, the thermal barrier covering at substantial area of either an interior or an exterior surface of the at least one sidewall;
an oil absorbent material, the oil absorbent material being filling a portion of the interior volume; and
a perforated top, the perforated top being contained within the interior volume and substantially covering the oil absorbent material.

2. The container of claim 1, wherein the oil absorbent material comprises an amorphous silica particulate.

3. The container of claim 1 wherein the receptacle is made of a biodegradable material.

4. The container of claim 3, wherein the receptacle is comprised of paper.

5. The container of claim 3, wherein the cover is comprised of a biodegradable material.

6. The container of claim 1, wherein the thermal barrier is located in the interior volume and covers a substantial area of the interior surface of the at least one sidewall.

7. The container of claim 1, wherein the thermal barrier is comprised of corrugated cardboard.

8. The container of claim 2, wherein is treated with a solution to enhance the adherence of the amorphous silica particles to one another to reduce the generation of airborne dust.

9. The container of claim 2, wherein the amorphous silica particulate is adapted to absorb at least 8 times its weight in oil.

10. The container of claim 1, wherein the perforated top is comprised of corrugated cardboard.

11. The container of claim 6, wherein the perforated top rests on and is supported by a top edge of the thermal barrier.

12. The container of claim 6, wherein the thermal barrier and the perforated top are unitary.

13. The container of claim 1, wherein one or more of the receptacle, the cover, the thermal barrier and the perforated top are comprised substantially of a biodegradable polymeric material.

14. The container of claim 1, wherein cover and the perforated top are integrally molded as a unitary component.

15. In combination, the container of claim 1, a bowl having a perforated bottom side, and a stand wherein the bowl is adapted to rest in the stand with the container being located under the perforated bottom of the bowl.

16. A method of using the container of claim 1, the method comprising:
removing the cover from the receptacle to expose the open end thereof;
pouring oil into the container whereby the oil seeps through openings in the perforated top and is absorbed by the oil absorbent material;
placing the cover back over the open end of the receptacle to effectively enclose the interior volume; and
disposing of the container.

17. The method of claim 16, wherein said disposing of the container comprises placing the container in a trash can.

18. A method of using the container and combination of claim 15, comprising:
removing the cover from the receptacle to expose the open end thereof;
placing the container within the stand;
placing the bowl on the stand with its perforated bottom being located directly above the open end of the container;
pouring oil having solid particulate mixed therein into the bowl whereby the oil seeps through openings in the bowl and flows into the open end of the container;
disposing of the solid particulate captured in the bowl;
placing the cover back over the open end of the receptacle to effectively enclose the interior volume; and
disposing of the container.

19. A method of making a container for holding oil, the method comprising:
providing a receptacle, the receptacle having at least one sidewall, a bottom and an at least partially open top end defining an interior volume;
providing a cover, the cover being adapted for receipt over the open top end to fully enclose the interior volume;
providing an oil absorbing material, the oil absorbent material being of a sufficient volume to fill a substantial portion of the interior volume;
providing a perforated top, the perforated top adapted to be contained within the interior volume and substantially covering the oil absorbent material;
providing a thermal barrier; the thermal barrier being capable of covering at least a substantial area of either an interior or an exterior surface of the at least one sidewall;
assembling the container by (i) covering the interior or exterior surface of the at least one side wall with the thermal barrier, (ii) filling the interior volume with the oil absorbant material, (iii) placing the perforated top over the oil absorbent material in the interior volume, and (iv) placing the cover over the open end.

20. A container for holding oil, the container comprising:
a frustoconically-shaped receptacle comprised of a biodegradable paper having at least one sidewall, a bottom and an at least partially open top end defining an interior volume;
a cover comprised of a biodegradable paper adapted for receipt over the open top end to fully enclose the interior volume;
a thermal barrier comprised of a biodegradable corrugated cardboard material distinct from the at least one sidewall, the thermal barrier covering at substantial area of an interior of the at least one sidewall;
an oil absorbent material consisting substantially of amorphous silica particulate, the oil absorbent material being filling a substantial portion of the interior volume; and
a perforated top comprised of a biodegradable paper, the perforated top being contained within the interior volume and substantially covering the oil absorbent material.
